(19) United States
(12) Patent Application Publication
(10) Pub. No.: US 2025/0243640 A1
(43) Pub. Date: Jul. 31, 2025

(54) TAILINGS STORAGE FACILITY METHOD AND STRUCTURE

(71) Applicant: ANGLO AMERICAN TECHNICAL & SUSTAINABILITY SERVICES LTD, London (GB)

(72) Inventors: Anthony Owen FILMER, Brisbane (AU); Philip Duncan NEWMAN, London (GB)

(21) Appl. No.: 18/855,736

(22) PCT Filed: Apr. 21, 2023
(86) PCT No.: PCT/IB2023/054071

§ 371 Date: Oct. 10, 2024

Related U.S. Application Data
(60) Provisional application No. 63/333,978, filed on Apr. 22, 2022.
(60) Provisional application No. 63/340,022, filed on May 10, 2022.
(60) Provisional application No. 63/408,650, filed on Sep. 21, 2022.

(51) Int. Cl. E02D 3/10; C02F 11/121; C02F 103/10

(52) U.S. Cl. CPC E02D 3/106; C02F 11/121; C02F 2103/10

(57) ABSTRACT

THIS invention relates to a method of constructing a tailings storage facility structure, and to a tailings facility structure. The structure comprises a network of sand channel arteries 10 and permeable capillaries extending through tailings 14. The sand channel arteries 10 are continuous in the vertical and one lateral dimension and connect to a decant point or points. The permeable capillaries 12 are connected at their lowest point to a sand channel artery, and are continuous in one lateral dimension. The capillaries 12 transport water from the tailings 14 to the sand channel arteries 10, and the sand channel arteries transport water from the capillaries 12 and the tailings 14, to the water decant point or points.

This patent application claims priority from U.S. Ser. No. 63/333,978, U.S. Ser. No. 63/340,022 and U.S. Ser. No. 63/408,650, the contents of which are incorporated herein by reference.

### BACKGROUND OF THE INVENTION

The consumption of water in mining operations is significant and is often a major issue for local communities, particularly in areas which are water deprived. The mine tailings are the major component of water consumption in most mining activities. Furthermore, tailings are deposited in dams and remain saturated and subject to liquefaction under stress. The revegetation of these saturated tailings is difficult. So, at the end of mine life, the tailings management facility represents an ongoing and undesirable legacy for the community.

To recover water from the saturated tailings, the concept of continuous sand channels co-deposited in a multi-layer structure with mine tailings, to de-saturate tailings and recover water from the sand channels, has been described in Filmer et. al. (WO 2020/183309). In WO 2020/183309, tailings are deposited layers of prescribed depth onto a sand layer. The freshly deposited tailings are allowed to drain in a vertical direction to the nearest sand channel or layer, with air from above displacing some of the water in the tailings, hence desaturating the structure. The water migrates vertically through the low permeability tailings layer then laterally along a sand channel to a central decant point. The primary direction of water flow from the tailings into the sand layers in WO 2020/183309 is in the vertical direction. In lower layers, the water transfers vertically to a sand channel either below or above, then travels laterally to an ultimate decant point.

Ren et. al. (U.S. Pat. No. 9,188,389) also provides for water drainage predominantly in the vertical direction to a higher permeability layer, then migrating through the high permeability layer to the edge of the structure. Ren provides no facility for air ingress to enable the ongoing desaturation of lower layers of tailings.

The rate of any tailings dewatering can be described by Darcy's equation. The water flow is proportional to the permeability of the tailings in the direction of flow, and to the inverse of the distance water has to migrate through the tailings to reach a permeable channel, and to the differential pressure causing the migration.

Once in a permeable channel, the water needs to flow along that permeable channel with similar proportionalities, albeit with a much higher permeability, to a decant system, where it can be removed from the facility.

Each tailings produced from a mineral processing facility has a different particle size distribution that has been optimised for the particular ore processing, and hence the tailings permeability is different in every tailings facility. Furthermore, depending on the tailings composition and the deposition methods, every tailings has a different level of anisotropy between the vertical and horizontal planes in the deposited tailings; with the horizontal permeability typically being around 5-10 times greater than the vertical permeability. https://books.gw-project.org/hydrogeology-and-mineral-resource-development/chapter/representative-hydraulic-properties-of-mine-wastes/

And since in some tailings dams, the coarser fraction of the tailings is used to provide the sand construction material for a dam wall, the permeability of both the remaining tailings and the coarser sand fraction is affected by the cut size of the classification and the efficiency of fines removal from the sand fraction.

In the case of application of WO 2020/183309, there is a further separation of sand for construction of the sand channels resulting in even further changes to tailings permeability and anisotropy.

The rate of dewatering of a tailings structure is also dictated by the differential hydraulic pressure at each stage of its journey along the channels. The water removal can only be as fast as its slowest step in the journey; from the pores between tailings particles to a nearby permeable channel, and then along the permeable channel to the decant point, then extraction from the facility by draining or pumping. The rate of the journey through the tailings, is dictated by the hydraulic conductivity in the direction of migration to the permeable channel, the distance to this channel, and the extent to which air can access the tailings to increase the differential hydraulic pressure.

Due to the naturally occurring anisotropy, flow in the horizontal direction in a tailings component of the structure will be faster than the vertical direction.

The rate of the journey through the permeable channels will be dictated by the hydraulic conductivity of the channel, the cross-sectional area of the channel, and the differential pressure gradient along the channel. The pressure head will also be dictated by the extent to which air can access the permeable channel to fill the voids caused by the displacement of water.

It is an object of the present invention to enable more effective recovery of water from the tailings both in the rate and total amount of water recovered, using a method that is applicable to greenfield and currently operating tailings storage facilities, and to provide a method for partially dewatering historical tailings.

It is also an object of the present invention to provide for safe and efficient constructability of a dewatered tailings storage, utilising predominantly materials that are already present in the tailings, and to place these materials with minimum disruption to normal tailings deposition.

### BRIEF DESCRIPTION OF THE DRAWINGS

FIG. 1A is a plan view of a schematic representation of an embodiment of the invention showing the placement of sand arteries and capillaries;

FIG. 1B is a cross-section through FIG. 1A along the line X-X;

FIG. 2 is a photograph of a self-propelled cyclone unit which can be used to produce sand arteries;

FIG. 3A is a plan view of a schematic representation of an embodiment of the invention showing a tailings storage facility with both arteries and capillaries;

FIG. 3B is a cross-section through FIG. 3A along the line Y-Y

FIG. 4 is a schematic elevation view of a coarse sand channel according to an embodiment of the invention

FIG. 5 is a side view of a schematic representation of the construction of sand arteries in a tailings storage facility;

FIG. 6A is a side view of a schematic representation of the construction of sand arteries and capillaries in a tailings storage facility;

FIG. 6B is a cross section of FIG. 6A along the line Z-Z;

FIG. 7A is a schematic elevation view of a coarse sand channel according to an embodiment of the invention, constructed on an existing tailings facility; and

FIG. 7B is a cross section of FIG. 7A.

### SUMMARY OF THE INVENTION

According to a first aspect of the present invention, there is provided a method of constructing a tailings storage facility structure on tailings surface wherein:
a network of sand channel arteries that are continuous in the vertical and one lateral dimension, and defining an upper surface, is deposited progressively on a base surface of the tailings structure, the network being spaced across the tailings surface, with the arteries connecting to a decant point or points; and
tailings are deposited into the structure, with channel arteries deposited progressively so that the upper surface of the arteries extends above the tailings; wherein:
the sand channel arteries transport water from the tailings, to the decant point or points, and the sand channel arteries extending above the tailings promote for ingress of air into the tailings structure.

The sand channel arteries may be around 2 m to 5 m in width, and extend from the base surface of the tailings structure up through and above a surface of the tailings to a height above the tailings surface by around 0.5 to 3 m.

By “tailings” is meant a residue from processing with a p80 of less than 0.3 mm, containing more than 20% by mass of material <75 micron, initially present as a slurry.

By “sand” is meant a free draining solid, which may be generated from the processing tailings, which has a p80 of greater than 0.15 mm and containing less than 15% by mass of material <75 micron.

The sand size is selected to be consistent with Terzaghi's guidelines to avoid the infiltration of fine tailings into the coarser sand. Such infiltration would reduce the sand permeability.

The sand may be formed from the processing tailings by hydraulic or hydro-cyclonic classification, prior to deposition of the tailings. Alternatively, the sand may be introduced from external sources.

A network of permeable channel capillaries that are connected at their low point to a sand channel artery, and are continuous in one lateral dimension, may be deposited in the structure, with the network of capillaries being spaced both laterally and vertically through the structure; wherein the capillaries transport water from the tailings to the sand channel arteries, and the sand channel arteries transport water from the capillaries and the tailings, to a decant point or points, and the sand channel arteries and capillaries promote the path for ingress of air into the tailings structure.

The permeable capillaries, that provide a pathway for water from the tailings to the artery channels, and for air from the artery channels into the tailings, may be constructed from sand, or may be commercially manufactured wick drains, or another permeable medium.

Typically, the permeable capillaries are deposited to slope upwards, for example at an angle of 0.1 to 5 degrees to the horizontal, with a height of 2 mm to 500 mm, and a width of 50 mm to 1000 mm.

A network of sand channel arteries may comprise a main sand channel artery extending longitudinally along the tailings surface and sub-sand channel arteries extending radially from the main artery.

Typically, the arteries and capillaries are constructed whilst continuous flow of tailings is maintained into the storage facility. This flow may be controlled across parts of the facility to provide for suitable conditions for artery or capillary construction.

The flow of water through the sand channel arteries can be further accelerated by including a pathway constructed from a material with very high permeability, which can absorb water from the sand along its length. For example, a porous pipe or coarse gravel, having very high permeability, is laid near the base or at intermediate levels of the sand artery during construction of the artery, and later becomes submerged in sand as the artery is increased in height. The pipe effect provides for more rapid flow of water from multiple points along the length of the artery to the ultimate water discharge point.

The flow of water through the permeable capillaries can be increased by increasing the slope of the capillary, typically laid such as to slope down the natural beaching angle of the tailings deposit, for example at an angle of 0.1 to 5 degrees to the horizontal, and by increasing the cross-sectional area of the capillary.

The level of water in the arterial network may be drawn down, either intermittently or permanently, to provide for ingress of air into the lower levels of the structure.

The permeable capillaries may be constructed between two arteries to enable air access to the upper end of a capillary from one artery, and hence enhance the gravity flow of water along the capillary to the other artery.

The permeable capillaries may be constructed with an elevated point or knob near the highest end of the capillary, to enable ongoing air access to the sand even when most of the remainder of the capillary is covered with tailings.

Preferably, a distance from any point in the tailings being deposited to the nearest artery is less than 100 m, and preferably less than 50 m and even more preferably around 30 m.

Preferably, a vertical distance between adjacent permeable capillaries is less than 10 m, and preferably less than 5 m, and even more preferably around 2 to 3 m.

Preferably, a horizontal distance between adjacent permeable capillaries is less than 20 m, and preferably less than 10 m, and even more preferably around 3 to 5 m.

The capillaries may be constructed on the surface of tailings such as to slope upwards, from the connection to the arterial network towards their endpoint higher in the tailings structure, which may be a connection to another artery.

The tailings surface available, on which to deposit fresh tailings at any time, is preferably more than 75%, and preferably more than 85% and preferably around 90% of the total area of the structure. This provides flexibility in the location of deposition points and limits the rise rate of tailings in specific areas of the facility.

Where the sand arteries are constructed on a pre-existing conventional tailings dam, they may be used as a platform for inserting vertical drains into a historical tailings storage below. As examples, the vertical drains may be the commercial wick drains widely used in the construction industry. Alternatively, vertical sand drains can be placed down through historical tailings. By vertical drains, is meant drains with a vertical vector, including those angled to maximise tailings coverage, placed to collect water from the historical tailings below. These vertical drains inserted into the historical tailings facility provide a pathway for water to migrate into the drain then rise to the surface of the historical tailings, and into the sand artery channel, from where the water can flow out of the structure. Over time, the historical tailings will have a demonstrably lower risk of liquefaction.

These flows to recover water from the tailings below, can occur whilst additional tailings is being deposited above, effectively increasing the pore pressure to squeeze water out from the historical tailings.

The vertical drains may also be inserted in locations between arteries during the active life of the tailings facility, by either using a machine capable of operating on a saturated tailings surface such as a Phibion. https://www.phibion.com, or by ceasing tailings deposition in an area for a sufficient duration to provide safe access to the consolidated tailings surface, for drain installation.

The current invention may also be used for remediating historical tailings facilities, including water recovery, where historical tailings are reclaimed, possibly beneficiated, and classified to generate sufficient sand, prior to stacking in a new storage location.

The permeable sand arteries and capillaries also provide channels that rapidly reduce the exposed water on the surface of the tailings structure, and hence reduce evaporation. The area of exposed surface water using the current invention is less than 25% of the total tailings area, and preferably less than 10% and even more preferably less than 5% of the total tailings area.

Sand used to form the sand channels preferably has less than 15% of fines <75 micron, and preferably less than 10%, and even more preferably around 5% or less.

The construction of the sand arteries and capillaries may take place on, and substitute for, an active conventional tailings storage facility.

The source of the sand may be recovered directly after coarse particle flotation or magnetic separation; or may be generated by classifying conventional tailings from a flotation or leaching process to form a sand fraction and a slimes enriched tailings fraction.

This invention also relates to a tailings storage facility structure comprising:
a network of sand channel arteries that are continuous in the vertical and one lateral dimension, and defining an upper surface, deposited on a base surface of the structure, the network being spaced across the tailings surface, with the arteries connecting to a decant point or points; and
tailings deposited within the structure, with the upper surface of the arteries extending above the tailings; wherein:
the sand channel arteries transport water from the tailings, to a decant point or points, and the upper surface of the sand channel arteries extend above the tailings to promote for ingress of air into the tailings structure.

The sand channel arteries may be around 2 m to 5 m in width, and extend from the base surface of the tailings structure up through and above a surface of the tailings to a height above the tailings surface by around 0.5 to 3 m.

A network of permeable capillaries that are connected at their low point to a sand channel artery, and are continuous in one lateral dimension, may be deposited in the structure, with the network being spaced both laterally and vertically through the structure; wherein
the capillaries transport water from the tailings to the sand channel arteries, and the sand channel arteries transport water from the capillaries and the tailings, to a decant point or points, and the sand channel arteries and capillaries promote for ingress of air into the tailings structure.

Typically, the permeable capillaries slope upwards, for example at an angle of 0.1 to 5 degrees to the horizontal and have a height of 2 mm to 500 mm, and a width of 50 mm to 1000 mm.

A network of sand channel arteries may comprise a main sand channel artery extending longitudinally along the tailings surface and sub-sand channel arteries extending radially from the main artery.

Preferably, the permeable capillaries have access to air at their upper end, either through a sand artery or through an elevated point or knob to enable ongoing air access to the sand when most of the remainder of the capillary is covered with tailings.

The distance from any point in the tailings to the nearest artery is typically less than 100 m, and preferably less than 50 m, and even more preferably around 30 m.

The distance from any point in the tailings to the nearest permeable capillary is typically less than 10 m, and preferably less than 5 m, and even more preferably around 2 to 3 m.

The vertical distance between adjacent the permeable capillaries is typically less than 10 m, and preferably less than 5 m, and even more preferably around 2 to 3 m.

The horizontal distance between adjacent the permeable capillaries is typically less than 20 m, and preferably less than 10 m, and even more preferably around 3 to 5 m.

The capillaries preferably slope upwards, for example at an angle of 0.1 to 5 degrees to the horizontal, from the connection to the arterial network towards their endpoint higher in the tailings structure.

The sand used to form the arteries and potentially the capillaries typically has less than 15% of fines <75 micron, and preferably less than 10%, and even more preferably around 5%.

### DESCRIPTION OF PREFERRED EMBODIMENTS

A sand fraction of mine tailings, defined as the fraction of the residue material classified to contain <15% below 75 microns in diameter, can be separated from remaining tailings either during the beneficiation using processes such as coarse flotation, or by separate classification of the tailings stream to produce a sand fraction and a tailings fraction.

Separating the mine residues into a sand and a tailings fraction, creates the potential to place the sands separately within the tailings, to form permeable sand channels.

The current invention provides a structure and a method for constructing a tailings storage facility consistent with the principles underpinning rapid and effective dewatering of the tailings and removal of water from the structure.

The current invention also provides a structure and method for constructing such a storage facility on the surface of a currently active conventional tailings facility, or by reclaiming part or all of a historical tailings storage facility, such as to dewater the previously deposited tailings.

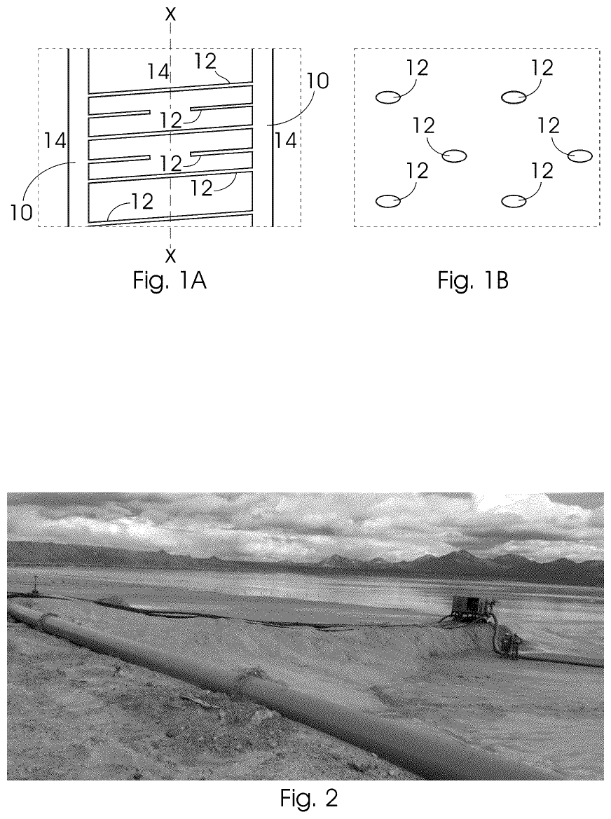

With reference to FIGS. 1A and 1B, the invention is the design and placement of a network of permeable channels comprising sand channels 10 that are continuous in the vertical and one lateral dimension, and laterally oriented permeable channels 12, distributed through the tailings 14 to expedite the transfer of water from the tailings 14, and allow air into the tailings, thus dewatering the tailings 14. Air enters through the upper surface of the sand channels 10 which extend above the surface of the tailings 14.

The vertically oriented air and water permeable channels 10 are analogous to the arteries, and the lateral permeable channels 12 to the capillaries distributed through a human body, with the arteries 10, around 2 m to 5 m in width, and extending from their base up through and above the surface of the tailings to a height above the tailings surface by around 0.5 to 3 m, carrying the bulk flow of water collected from the tailings by the smaller capillaries 12. The capillaries 12 are smaller permeable channels, designed and inserted to collect water from those locations that are further from the arteries 10. The weight of the tailings 14 extrudes pore water from the tailings 14 into the capillaries 12.

In the current invention, the sand may be generated by classification adjacent to the tailings facility, and then pumped through relocatable piping to the location of the sand deposition. As the sand channel arteries are proud of the tailings surface, their construction forms a stable surface across the tailings structure for normal mobile equipment to position the piping and sand discharge spigot. On deposition, the sand dewaters by gravity and raises the height of the sand artery, with the water flowing out from the deposition point into the adjacent tailings area.

Alternatively, sand can be placed using purpose-built commercially available equipment such as a cyclone deposition unit such a that illustrated at FIG. 2 and/or a hydraulic sand flinger. The cyclone deposition unit for sand placement is known in the industry. Sand containing slurry is pumped to a cyclone mounted on a mobile device. The free draining sand underflow from the cyclone is deposited directly in front of the mobile device, and the cyclone overflow stream containing mostly water and fine tailings is deposited into the adjacent tailings area.

The cyclone deposition unit can then create its own sand road base and proceed across the surface of the underlying tailings. Hence the unit can be used to build sand channels across an already prepared surface, or an existing tailings facility or a historical tailings surface.

The hydraulic sand flinger is a device in which a sand slurry is pumped through an orifice to accelerate the velocity of the sand slurry and direct the slurry stream to deposit the sand up to distances of around 70 m. The sand settles on the surface of the tailings and the water flows away from the deposited sand by gravity down the beaching angle of the tailings.

By repetitive deposition of additional sand over an existing sand channel artery, that is standing proud from the slowly rising level of tailings, the sand discharge spigot or the cyclone deposition unit or equivalent can create channels of sand that are continuous in both the vertical and a lateral dimension, through a gradually rising tailings facility.

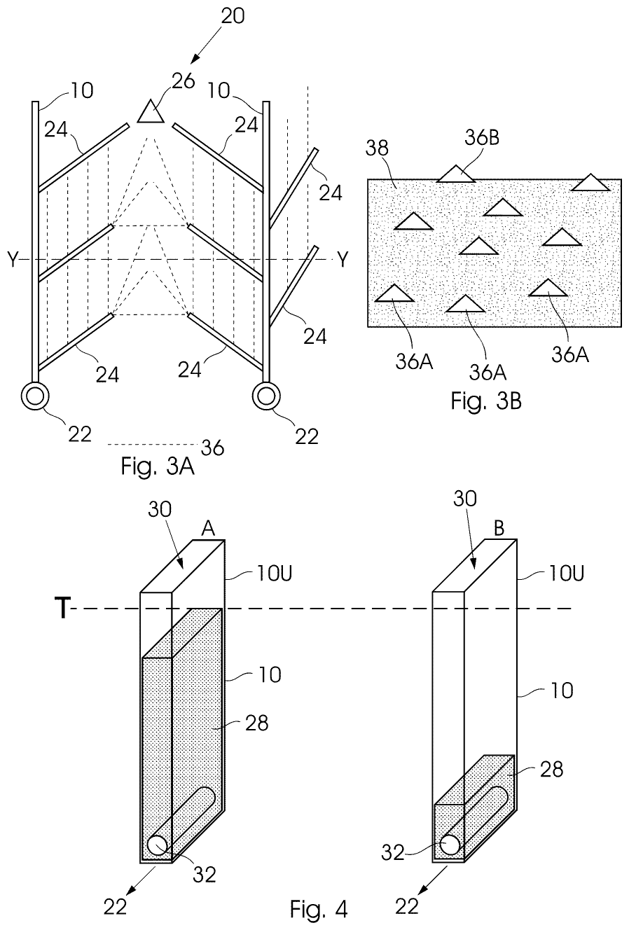

Effectively, the sand channels form an array of vertical sand curtains placed in a network within the tailings matrix, as illustrated in FIG. 3A. This schematic representation shows a tailings storage facility structure 20 comprised of main channel arteries 10, that are that continuous in both the vertical and a lateral dimension, and flow into decants point 22. Sub-channel arteries 24, that are also continuous in both the vertical and a lateral dimension, flow into the main channel arteries 10. A tailings discharge spigot 26 discharges tailings across the structure 20. The distance from any point in the tailings to the nearest artery 10/24 is typically around 25 m.

Water which enters these sand channels 10 and 24 from the surrounding tailings, will flow by gravity through the sand to a decant point 22 located at a lower elevation, and so be removed from the facility 20. In effect these vertically and laterally continuous channels form arteries to carry water through the structure and allow air access into the tailings structure through the upper surfaces of the channels 10 and 24 which extend above the tailings surface.

The sand channel arteries 10 and 24 can influence the direction of flow of tailings. They create a high contact area of sand to absorb the water from the tailings, and also create the opportunity for many potential decant locations.

By placing these sand channels through the tailings facility, the water from freshly deposited tailings can enter the arteries and flow along the artery beneath the surface of the facility. As such evaporative loses of water can be reduced, and the beaching angle of the tailings can be increased.

These sand arteries 10 and 24 through the tailings structure 20 lead to one or more decant points 22. Optionally the arterial sand channels can be connected to draw down the water at a single decant point, or multiple decant points can be provided through the structure to enable independent draw down of water in specific parts of the structure.

The decant points are usually located at a low point of the artery, to create a phreatic surface well below the surface of the tailings, by pumping water from the arteries.

Building these sand arteries 10 and 24 in a vertically continuous manner, with an upper surface of the sand arteries extending above the surface of tailings, enables air to enter the artery as the phreatic surface is pumped down. By so doing, air can be distributed through the tailings structure, as shown in FIG. 4.

In FIG. 4, “A” shows a sand channel artery 10, allowed to accumulate water 28, which flows from a decant point 22 to a water storage facility. “B” shows a sand channel 10 with water 28 drawn down the channel 10, which flows from a decant point 22 to a water storage facility. An upper surface 10U of the sand channel 10 extends above the surface T of tailings deposited in the structure and promotes air flow 30 through the structure.

In an embodiment of the invention, a slotted pipe 32 coated with water permeable geotextile, or equivalent highly permeable material, may be provided at the base of the channel artery 10 to facilitate the drainage of water therefrom.

By pumping water rapidly and lowering the phreatic surface in the sand, air can be distributed through the arteries that traverse through the gradually rising tailings structure. By slowing the pumping at the decant point, the water level in the arteries will rise, thus enabling at least some degree of water storage within the heap. This water buffering capacity enables continuity of water balance between the tailings storage facility and return system for recycling water to the processing facility.

With reference to FIG. 3A, main sand arteries 10 extend across the tailings dam, and a series of narrower but still vertically and horizontally continuous sub-arteries 24 can be built out across the tailings facility using a fleet of cyclone deposition units. Each sub-artery 24 is connected, at least at one end, to the main arteries 10, thus increasing the arterial network coverage and rapid water flow across the tailings storage, in a manner comparable to blood distribution in the body.

These sub-arteries 24 are vertically continuous, extending above the tailings surface, to allow draw down of the phreatic surface hence further enhance the transfer of both water and air through the tailings facility.

By forming the equivalent of vertical blankets of permeable sand through the tailings, these arteries 10 and sub-arteries 24 take advantage of the natural anisotropy or horizontal to vertical permeability ratio, of tailings. This permeability ratio is typically around 5-10. (http://www.scielo.org.za/pdf/jsaice/v60n3/05.pdf).

Depending on the particular tailings permeability, these vertical blankets alone can desaturate freshly deposited tailings located within say 20-30 m of an artery within a period of a few months.

With reference to FIGS. 3A and 3B, operating from the surface of the main arteries 10 and sub-arteries 24, permeable capillaries 36 can be placed outwards onto the surface of the tailings surface in a pattern to maintain gravity flow down to a low point where the capillary meets the arterial network. i.e. to maintain a continuous sand connection from the end of each capillary down to a sub-artery 24. The side elevation at FIG. 3B shows capillaries 36A previously laid on the surface of the rising tailings 38, and a fresh capillary 36B being laid on the surface of the tailings 38.

The permeable capillaries 36, that provide a pathway for water from the tailings to the artery channels 24 and for air into the tailings, may be constructed from sand or may be wick drains, as described in Santi et. al. Design and Installation of Horizontal Wick Drains for Landslide Stabilization, January 2001, Transportation Research Record Journal of the Transportation Research Board 1757(1):58-66 (https://www.researchgate.net/publication/245559752), the content of which is included herein by reference. The distance from any point in the tailings to the nearest capillary 36 is typically about 3m, the vertical distance between adjacent capillaries 36 is typically around 3m, and the horizontal distance around 5 m. Typically the capillaries slope upwards at an angle of 0.1 to 5 degrees to the horizontal.

The permeable capillaries 36 can also connect two arteries 10 or 24 at different elevation levels, thus maintaining gravitational assisted flow of water through the capillary and the ability to introduce air to one or both ends of the capillary 36. The capillaries 36 typically have a height of 2 mm to 500 mm, and a width of 50 mm to 1000 mm. When the capillaries 36 are wick drains they take on the height and width of the commercial product (e.g. say 5 mm by 50 mm) although a range of dimensions are available. Capillaries 36 made from sand formed by flinger they will be widespread and uneven in height (e.g. say 20 mm by 1000 mm). Capillaries 36 made from sand formed by cyclone deposition unit must support some weight of vehicle, so they will be (say 500 mm by 1000 mm), Capillaries 36 made from sand placed from the back of amphibious vehicle will be (e.g. 50 mm by 100 mm).

Unlike the arterial network, these capillaries 36 are not vertically continuous, but rather are spread intermittently on the rising surface of the tailings to promote a proximate collection point for any location in the tailings, to a high permeability channel flowing to the arteries. They can also be spaced through the structure to take advantage of the natural anisotropy of the tailings thus enabling water migration paths predominantly along the favoured lateral plane.

As the capillaries 36 are connected to but are not the main arterial routes 10 for rapid water or rapid air flow, their vertical continuity to the surface of the structure is not critical.

The capillaries are continuous in one lateral dimension and may be constructed from sand, or may be wick drains, or any other permeable structure.

The rate of water ingress to a capillary can be further enhanced by provision of a thin horizontal lens of sand deposited using a device like the hydraulic sand flinger on the surface of the tailings, to intersect with capillary and provide a pathway for faster lateral transport of water from the tailings to the capillary.

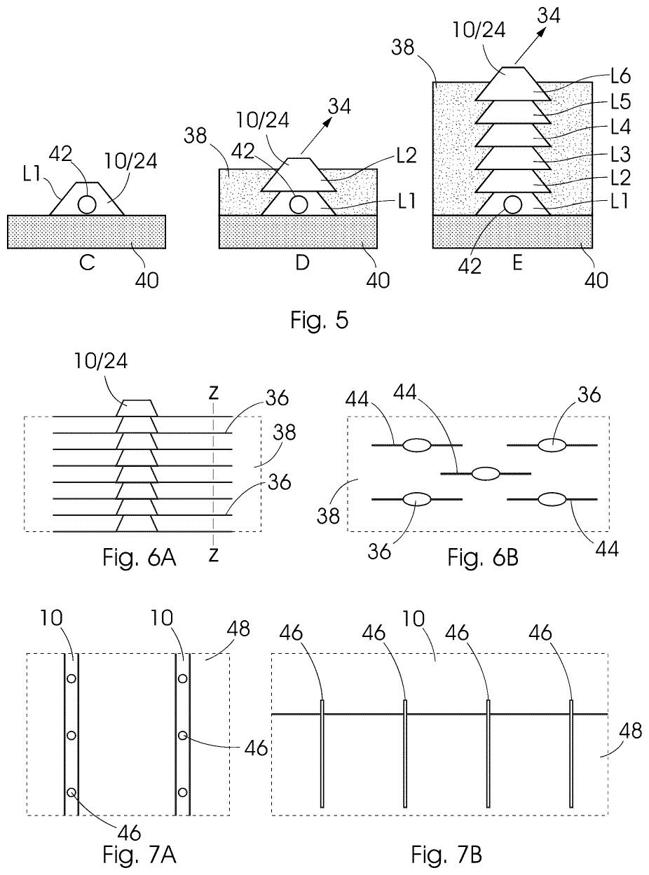

FIG. 5 shows a side elevation of the construction of a sand artery 10/24, that is continuous in both the vertical and a lateral dimension on an existing tailings base 40. At “C”, a first lateral sand channel L1 is deposited in a lateral continuous mound using a sand discharge mechanism mounted on a mobile device. At “D”, the cyclone deposits another mound of sand L2 forming another layer of sand L2, on top of the first layer L1, thereby extending the artery 12/16 in the vertical plane. Tailings 38 are pumped into the structure so that the arteries 10/24 protrude only a short height above the tailings at any time, and thus the required amount of sand required is reduced by spreading the sand such that it rills out over the tailings surface. “E” shows multiple layers L1-L5 as the structure is constructed with the arteries extending further in the vertical plane, and the tailings extending upwards with the arteries 10/24. In this example, water 34 will flow as indicated by the arrow into the page. In an embodiment of the invention, a slotted pipe 42, coated with water permeable geotextile or equivalent water permeable material may be provided at the base of the sand artery 10/24 to facilitate the drainage of water therefrom.

Whilst the edges of this artery are structurally less load bearing, a vehicle can operate safely near the centre of the vertically continuous sand artery. After a short period, the tailings immediately adjacent to the sand channel is also desaturated and consolidated, hence increasing the load bearing capacity across the full artery.

With effective design to suit the terrain, the required distance from any individual point in the tailings facility to a continuous sub-artery can be reduced to less than 100 m, and preferably less than 50 m, and even more preferably around 30 m.

The continuous vertical blankets of arterial sand are maintained with only a small proportion of the overall operational tailings facility being constructed from sand. Utilising the ‘Christmas tree’ structure of these sand arteries 10 and sub-arteries 24 as illustrated in FIG. 5, the requisite quantity of sand is well within the constraints of that available from a processing facility.

For example, if the spacing between the centres of arteries and sub-arteries is 40 m, and on average the arteries and sub-arteries are 4m wide to support the traversing of equipment, around 10% of the total residue is sand, and 90% is tailings. If for example sand is produced by coarse particle flotation with a p80 grind size of around 0.35 mm, around 25% of the total residue will be recoverable as sand directly from the coarse flotation machine.

For conventional flotation processing, with a p80 of 0.2 mm, around 10% of the tailings is typically recoverable as a sand suited for dam wall construction using normal cyclones. And if for example, a conventional flotation tailings is classified using a hydraulic classifier, to produce a sand containing less than 10% minus 75 micron, around 25% of the typical flotation tailings can be recovered as sand. If the arterial sand is recovered from normal flotation tailings using a hydrocyclone or hydraulic classifier, it will have a finer p50, but the low level of <75 micron silt ensures its satisfactory permeability.

Hence, adequate sand for artery formation can be produced from the processing tailings prior to its deposition. This sand may also be supplemented with, or substituted by external sand source that has a suitable PSD.

Where the permeability of the tailings is low, or where rapid dewatering and consolidation of the tailings is desirable, or where a greater distance between the arterial spokes is required to conserve sand, a further network of connected capillaries can be created within the tailings matrix, to supplement the water collection by the arteries alone.

FIGS. 6A and 6B show the deposition of capillaries 36, connected to an artery 10/24, within the tailings 38. The capillaries 36 are designed to absorb water along their length; and transfer this water down the capillary to an artery 10/24, and hence out of the facility. The pore pressure of water in the tailings causes the migration of the water into the capillary, and along its length to the artery. When the surrounding tailings is desaturated, the capillaries can also help the transfer of air into the tailings structure. The capillaries may be constructed from sand, or may be commercially available wick drains, or other suitable permeable material.

With reference to FIGS. 6A and 6B, as one embodiment, a hydraulic sand flinger can be used to further enhance the lateral coverage of the permeable capillary channels in the horizontal plane. Through the placement of a thin layer of sand 44 laid adjacent to the capillary 36, or adjacent to an artery, horizontal water flow through tailings to the nearest sand channel artery is enhanced. Whilst this thin sand layer may not be adequate to provide for a rapid water flow rate to the nearest artery, it will reduce the distance that water must transfer through the impermeable tailings layer. In effect, the thin sand layer acts to increase even further the natural anisotropy of the tailings. In effect, the increase in lateral hydraulic conductivity provided by the thin sand layer 44 may enable the spacing between arteries and capillaries to be increased or may enable the duration over which the freshly deposited tailings is subject to liquefaction to be decreased. Typically, the thin sand layer 44 will average less than 50 mm thick, and preferably around 1-5 mm. Even if the continuity of the thin sand layer, deposited using a device such as the sand flinger, is broken by future tailings deposition, the distance water must travel through the lowest permeability tailings to reach a permeable channel, is much reduced.

By laying a capillary located intermittently on the rising surface of the tailings, and then allowing the ongoing deposition of tailings to overtop the capillary 36, the capillaries 36 can permeate the tailings in a 3-dimensional network structure at a multitude of heights through the tailings, using relatively small proportions of sand or acceptable lengths of wick drain.

If the capillaries do not extend between two arteries, a high point or ‘knob’ can be formed near the upper end of the capillary to extend the duration of air access before the capillary is overtopped by the rising tailings. This high point or knob will enable air access into the capillary, even when most of the capillary is submerged in freshly deposited tailings. i.e. the equivalent of a breather hole into the underlying tailings structure.

Ideally this high point or knob should remain above the fresh tailings surface for sufficient time that the capillary has effectively dewatered the surrounding tailings, and the immediate adjacent tailings has already filled with a significant proportion of air.

If the capillaries are constructed from sand, they can be deposited intermittently on the gradually rising surface of the tailings by a cyclone deposition unit or a hydraulic sand flinger or an amphibious vehicle that can operate on a tailings surface. If the capillaries are constructed from wick drains, this can be carried and unfurled by an amphibious vehicle travelling across the surface of the freshly deposited tailings, or and similar method of transporting and placing the required length of wick drain. Such an amphibious vehicle may be automated to enable remote placement of wick drains.

The furrows created in the surface of the tailings by an amphibious vehicle can be utilised to protect the capillary from subsequent tailings deposition flows, and hence reduce the potential for capillaries to be displaced or eroded by future tailings deposition.

The construction of the capillaries is such that they are preferably connected to the arterial network at the lowest elevation of the capillary. The capillary spacing, and depth does not need to be precise, but rather to ‘fill the gaps’ in the tailings space between arteries, such as to at least partially optimise the proportion of water that can flow laterally along the direction of maximum tailings permeability.

Optionally, a capillary connection can occur between arteries at different elevations. By drawing down the phreatic surface in the upper-level artery, air can enter the top of the capillary. Such a connection will accelerate dewatering by allowing increased air ingress into the capillary ‘releasing the vacuum’. By maintaining a low phreatic surface in the upper artery, the capillary remains open for air ingress long after it is submerged in tailings.

And even if some parts of the capillary are inadvertently ‘islanded’ either during construction, or erosion by the fresh tailings flows, or by subsidence along their length such that airflow is limited, they will still enhance lateral permeability of water through the tailings.

In the case of sand capillaries, the vertical depth of the capillaries will typically be less than 0.5 metres, and even more preferably less than 10 cm.

Where a high point or knob is constructed on the end of the capillary, the height of the high point or knob will preferably be greater than 0.2 m above the surface of the tailings, and even more preferably greater than 0.5 m and even more preferably around 1 m or more.

In the case of a thin sand layer utilised to extend the lateral coverage of a capillary or artery, the depth can be less than 10 cm, and preferably around a few mm.

The capillaries can be located to benefit from the anisotropy of a particular tailings, as the lateral flow of water through the tailings is faster than the vertical flow. As such the lateral distance from any point in the tailings to the nearest capillary is less than 20 m, and preferably less than 10 m, and even more preferably around 3 to 5 m.

And the capillaries are located at reasonably regular heights through the tailings to minimise the vertical vector of water migration, preferably with vertical spacing of less than around 10 m, and more preferably around 2 to 3 m.

The duration, from the fresh deposition of tailings with well-located intermittent capillaries and arteries, to the time at which unconstrained flow of that tailings will no longer occur, is reduced to less than 30 days, and preferably less than 20 days and even more preferably less than 10 days. This rapid dewatering and consolidation of the tailings has a major effect on the overall safety of the facility, in the event of a rare and unforeseen event such as an impoundment failure.

Furthermore, the ability to remove water and distribute air in the tailings storage facility enables dewatering over time to similar levels as can be achieved using filtration equipment. In effect the weight of overlying tailings acts like a pressure filter, gradually squeezing water from the tailings, whilst allowing distributed air access through the structure to fill the voids between the fine tailings particles.

As such the water content of the facility is reduced, initially rapidly as the water is ‘squeezed out’ and then more slowly as air accesses and desaturates the 3-dimensional tailings structure. Ultimate moisture contents of the structure are preferably less than 20% by weight and even more preferably around 10-15% by weight.

The invention is such that an existing and active conventional tailings storage facility can be readily converted, by building arteries on top of the existing surface, and utilising these arteries for access to install the capillaries.

When the mine reaches the end of mine life, and deposition of tailings ceases, a conventional TSF is saturated and cannot support a normal range of vegetation or other uses. Using the current invention, ongoing dewatering can occur to further recover water from the structure. The surface layer desaturates to form the equivalent of soil. By reintroducing organic matter, the tailings facility can be readily converted into productive agricultural land or rehabilitated with natural vegetation, or converted into another useful function.

In a further embodiment of the invention, utilised on the surface of an existing or historical tailings facility, the sand arteries create a stable working platform across the surface of the tailings facility.

With reference to FIGS. 7A and 7B, if stabilizing the landform, or harvesting water from the underlying historical tailings is desired, the invention enables vertical drains 46 to be placed down through the underlying tailings facility 48, much as would be done for dewatering a construction site. The vertical drains 46 extend down into the underlying tailings facility 48, and up into a sand artery 10 as described above. The pore pressure of water in the underlying tailings will push water into a sand channel from where it can exit the structure.

Water is effectively mined from the underlying tailings and can be utilised to support ongoing mining or reused/disposed of in an appropriate manner.

By adjusting the spacing of the wick drains along the arteries, the dewatering rate can be adjusted according to the urgency of water recovery and the desired tailings consolidation in the historical storage facility. Using the technique, the historical tailings in the vicinity of a dam wall can be dewatered thus reducing the risk profile of a past or future centre line or upstream raise.

Alternatively, a historical tailings can be reprocessed and relocated. As an example, for a tailings in which the coarse fraction contains most of the value, the classification can separate a sand which is suitable feed for coarse flotation, the residue from which is well suited for creating the sand arterial network in the new structure.

The sand requirement for the construction of the arteries and capillaries may be around 3% to 15% of total volume.

In summary, the invention represents a readily constructed, interconnected network of sand channels, arranged to enable water flow out and air flow into a tailings structure, which utilises the directional permeability of tailings, to accelerate dewatering. In so doing, the invention enables reduced water consumption, safer production, efficient rehabilitation, and the potential for reprocessing existing tailings.

Advantages of the present invention include faster desaturation, enhanced water recovery, safe and effective operability, and the reduced long-term legacy of mining.

By appropriate spacing the arteries and capillaries, the rate of dewatering of tailings can be adapted to meet the design needs as specified by either specific location in the impoundment, or by overall stakeholder requirements.

1-65. (canceled)

66. A method of constructing a tailings storage facility structure wherein:
a network of sand channel arteries that are continuous in the vertical and one lateral dimension, and defining an upper surface, is deposited progressively on a base surface of the tailings structure, the network being spaced across the tailings surface, with the arteries connecting to a decant point or points; and
tailings are deposited into the structure, with sand channel arteries deposited progressively so that the upper surface of the arteries extends above the tailings; wherein:
the sand channel arteries transport water from the tailings, to a decant point or points, and the sand channel arteries extending above the tailings promote for ingress of air into the tailings structure.

67. The method claimed in claim 66, wherein the sand channel arteries are around 2 m to 5 m in width, and extend from the base surface of the tailings structure up through and above a surface of the tailings to a height above the tailings surface by around 0.5 to 3 m.

68. The method claimed in claim 66, wherein a network of permeable capillaries that are connected at their lowest point to a sand channel artery, and are continuous in one lateral dimension, are deposited in the structure, with the network being spaced both laterally and vertically through the structure; wherein the capillaries transport water from the tailings to the sand channel arteries, and the sand channel arteries transport water from the capillaries and the tailings, to the water decant point or points.

69. The method claimed in claim 68, wherein the permeable capillaries have a height of 2 mm to 500 mm, and a width of 50 mm to 1000 mm.

70. The method claimed in claim 66, wherein the network of sand channel arteries comprises a main sand channel artery extending longitudinally along the tailings surface and sub-sand channel arteries extending radially from the main artery.

71. The method claimed in claim 70, wherein the arteries and capillaries are constructed whilst continuous flow of tailings is maintained into the storage facility.

72. The method claimed in claim 66, wherein the flow of water through the sand channel arteries is accelerated by including a pathway constructed from a material with high permeability, which can absorb water from the sand along its length, for example, a porous pipe or coarse gravel having high permeability, is laid near the base or at intermediate levels of the sand artery during construction of the artery, and later become submerged in sand as the artery is increased in height.

73. The method claimed in claim 66, wherein a level of water in the arterial network is drawn down, either intermittently or permanently, to provide for ingress of air to the structure.

74. The method claimed in claim 68, wherein the permeable capillaries are constructed from sand, or wick drains, or other permeable medium.

75. The method claimed in claim 74, wherein flow of water through the permeable capillaries is increased by increasing the slope of the capillary.

76. The method claimed in claim 74, wherein the permeable capillaries are deposited at an angle of 0.1 to 5 degrees to the horizontal.

77. The method claimed in claim 75, wherein flow of water through the permeable capillaries is increased by increasing the cross-sectional area of the capillary.

78. The method claimed in claim 68, wherein the permeable capillaries are constructed with an elevated point or knob near the highest end of the capillary, to enable ongoing air access to the tailings when most of the remainder of the capillary is covered with tailings.

79. The method claimed in claim 66, wherein a distance from any point in the tailings being deposited to the nearest artery is less than 100 m, or less than 50 m, typically around 30 m.

80. The method claimed in claim 68, wherein a distance from any point in the tailings being deposited to the nearest permeable capillary is less than 10 m, or less than 5 m, or around 2 to 3 m.

81. The method claimed in claim 68, wherein a vertical distance between adjacent permeable capillaries is less than 10 m, or less than 5 m, or around 2 to 3 m.

82. The method claimed in claim 68, wherein a horizontal distance between the adjacent permeable capillaries is less than 20 m, or less than 10, or around 3 to 5 m.

83. The method claimed in claim 68, wherein the capillaries are constructed on the surface of tailings such as to slope upwards, from the connection to the arterial network towards their endpoint higher in the tailings structure.

84. The method claimed in claim 66, wherein a tailings surface available to deposit fresh tailings is more than 75% of the total area of the tailings structure.

85. The method claimed in claim 84, wherein a tailings surface available to deposit fresh tailings is more than 85%, or 90% of the total area of the tailings structure.

86. The method claimed in claim 66, where the tailings structure is constructed on a pre-existing conventional tailings dam, wherein the sand arteries are used as a platform for inserting vertical drains into a historical tailings storage below, and to subsequently allow the flow of water from these tailings out of the structure, whilst additional tailings is being deposited above.

87. The method claimed in claim 86, wherein the vertical drains are wick drains.

88. The method claimed in claim 66, wherein sand used to form the sand channel arteries and/or capillaries has less than 15%, or less than 10%, or less than 5% of fines <75 micron.

89. The method claimed in claim 68, wherein the construction of the sand arteries and capillaries takes place on, and substitutes for, an active conventional tailings storage facility.

90. The method claimed in claim 66, wherein the source of the sand is coarse particle flotation or magnetic separation, or generated by classifying conventional tailings from a flotation or leaching process to form a sand fraction and a slimes enriched tailings fraction.

91. A tailings storage facility structure comprising:
a network of sand channel arteries that are continuous in the vertical and one lateral dimension, and defining an upper surface, deposited on a surface of the tailings structure, the network being spaced across the tailings surface, with the arteries connecting to a decant point or points; and
tailings deposited within the structure, with the upper surface of the arteries extending above the tailings; wherein:
the sand channel arteries transport water from the tailings, to a decant point or points, and the upper surface of the sand channel arteries extend above the tailings to promote for ingress of air into the tailings structure.

92. The tailings storage facility claimed in claim 91, wherein the sand channel arteries are around 2 m to 5 m in width, and extend from the base surface of the tailings structure up through and above a surface of the tailings to a height above the tailings surface by around 0.5 to 3 m.

93. The tailings storage facility claimed in claim 91, wherein, a network of permeable capillaries that are connected at their lowest point to a sand channel artery, and are continuous in one lateral dimension, is deposited in the structure, with the network being spaced both laterally and vertically through the structure; wherein
the capillaries transport water from the tailings to the sand channel arteries, and the sand channel arteries transport water from the capillaries and the tailings, to a decant point or points.

94. The tailings storage facility claimed in claim 93, wherein the permeable capillaries slope upwards.

95. The tailings storage facility claimed in claim 94, wherein, the permeable capillaries slope upward at an angle of 0.1 to 5 degrees to the horizontal.

96. The tailings storage facility claimed in claim 95, wherein, the permeable capillaries have a height of 2 mm to 500 mm, and a width of 50 mm to 1000 mm.

97. The tailings storage facility structure claimed in claim 91, wherein the network of sand channel arteries comprises a main sand channel artery extending longitudinally along the tailings surface and sub-sand channel arteries extending radially from the main artery.

98. The tailings storage facility structure claimed in claim 93; wherein permeable capillaries have an elevated point or knob near the highest end of the capillary, to enable ongoing air access to the sand when most of the remainder of the capillary is covered with tailings.

99. The tailings storage facility structure claimed in claim 91, wherein a distance from any point in the tailings to the nearest artery is less than 100 m, or less than 50 m, typically around 30 m.

100. The tailings storage facility structure claimed in claim 93, wherein a distance from any point in the tailings to the nearest permeable capillary is less than 10 m, preferably less than 5 m, typically around 2 to 3 m.

101. The tailings storage facility structure claimed in claim 93, wherein a vertical distance between adjacent capillaries is less than 10 m, or less than 5 m, or around 2 to 3 m.

102. The tailings storage facility structure claimed in claim 93, wherein a horizontal distance between adjacent capillaries in the is less than 20 m, or less than 10 m, or around 3 to 5 m.

103. The tailings storage facility structure claimed in claim 93, wherein the permeable capillaries slope upwards, from the connection to the arterial network towards their endpoint higher in the tailings structure.

104. The tailings storage facility structure claimed in claim 91, wherein sand used to form the sand channels has less than 15%, or less than 10%, or around 5% of fines <75 micron.

105. The tailings storage facility claimed in claim 91, wherein a pathway of higher permeability is laid in the arteries to transfer water through the artery to the discharge point.

106. The tailings storage facility claimed in claim 105, wherein the pathway of higher permeability laid in the arteries to transfer water through the artery to the discharge point is a porous pipe.

107. The tailings storage facility in claim 93, wherein the porous capillaries comprise a sand or wick drains located in furrows formed in the tailings.

108. The tailings storage facility as claimed in claim 91, wherein the sand for construction of the arteries and/or porous capillaries is formed from a coarse beneficiation process such as coarse particle flotation or magnetic separation, or by classifying the existing tailings, prior to their deposition into the structure.

109. The tailings storage facility as claimed in claim 93, including thin layers of sand proximate to an artery or capillary.
